(19) United States
(12) Patent Application Publication
(10) Pub. No.: US 2022/0392338 A1
(43) Pub. Date: Dec. 8, 2022

(54) SAFETY NOTIFICATION DEVICE

(71) Applicant: Incredilab, Inc., Jupiter, FL (US)

(72) Inventors: Ryan Boysen, Palm City, FL (US); Brett J. Epstein, Jupiter, FL (US); Ahmed M. Ibrahim, Kanata (CA)

(21) Appl. No.: 17/805,125

(22) Filed: Jun. 2, 2022

Related U.S. Application Data
(60) Provisional application No. 63/195,760, filed on Jun. 2, 2021.

(51) Int. Cl. G08G 1/0955; G08B 21/18

(52) U.S. Cl. CPC G08G 1/0955; G08B 21/182

(57) ABSTRACT

Embodiments of a safety alert device and associated methods are disclosed. In one embodiment, the safety alert device includes a processing element and an image sensor in operative communication with the processing element. The processing element is configured to receive image data of a region of interest. The processing element determine a presence of a moving object in the region of interest based on the image data. The processing element is configured to identify a presence of a person in the region of interest based on the image data. The processing element determines a likelihood of a collision between the moving object and the person, and generates, based on the likelihood being above a threshold, an alert adapted to warn the person of the likelihood of the collision.

### CROSS-REFERENCE TO RELATED APPLICATIONS

This application claims the benefit of U.S. Provisional Patent Application No. 63/195,760, filed Jun. 2, 2021, entitled “SAFETY NOTIFICATION DEVICE”, the disclosure of which is incorporated herein by its entirety.

### FIELD

The described embodiments relate generally to systems and methods related to safety notification devices.

### BACKGROUND

Collisions between chasing objects such as vehicles with targets and cyclists are a cause of concern in many communities. With the rise of distracted driving brought on by the ubiquity of mobile phones, increasingly distracting car infotainment systems, and the like, targets are more at risk from vehicle impacts than ever. The risk is particularly great with children who may not carefully assess the safety of a roadway before entering into it and/or who may be prone to unintentional entrances into the roadway, e.g., falling off a bicycle.

Traditional solutions such as static signage (e.g., speed limit signs, yard signs, etc.) and speed bumps are typically inadequate because people, both drivers and targets, tend to ignore signs as they become part of the background of a street environment. Further, these solutions are not adaptive and cannot assess risk and respond appropriately to warn drivers and targets of that risk. Improved solutions are needed that can alert both targets and drivers of the risk of a collision.

### BRIEF SUMMARY

A safety alert device is disclosed. In one embodiment, the safety alert device includes a processing element; and an image sensor in operative communication with the processing element; wherein the processing element is configured to: receive image data of a region of interest; determine a presence of a moving object in the region of interest based on the image data; identify a presence of a person in the region of interest based on the image data; determine a likelihood of a collision between the moving object and the person; and generate, based on the likelihood being above a threshold, an alert

In one embodiment, a safety alert device includes a housing with an illumination area; a base coupled to the housing and configured to support the housing on a surface; a head removably coupled to the housing, wherein the head comprises: a circuit assembly, and one or more sensors in electrical communication with the circuit assembly.

A method of providing a safety notification is disclosed. In one embodiment, the method includes receiving, by a processing element, image data of a region of interest; determining, by the processing element, a presence of a moving object in the region of interest based on the image data; identifying, by the processing element, a presence of a person in the region of interest based on the image data; determining, by the processing element, a likelihood of a collision between the moving object and the person; and generating, by the processing element, based on the likelihood being above a threshold, an alert.

A non-transitory computer-readable storage medium is disclosed. In one embodiment, the computer-readable storage medium includes instructions that when executed by a processing element, cause the processing element to: receive image data of a region of interest; determine a presence of a moving object in the region of interest based on the image data; identify a presence of a person in the region of interest based on the image data; determine a likelihood of a collision of the moving object and the person; and generate, based on the likelihood being above a threshold, an alert adapted to warn the person of the likelihood of the collision.

### BRIEF DESCRIPTION OF THE SEVERAL VIEWS OF THE DRAWINGS

FIG. 1 is an isometric view of an embodiment of a safety notification device.

FIG. 2A is a partially exploded front elevation view of the safety notification device of FIG. 1.

FIG. 2B is a partial rear elevation view of the safety notification device of FIG. 1.

FIG. 3 is a simplified schematic view of components of the safety notification device of FIG. 1.

FIG. 4 is a simplified schematic view of components of the safety notification device of FIG. 1.

FIG. 5 is a simplified schematic view of components of the safety notification device of FIG. 1.

FIG. 6 is a flow chart of a method of generating a scene suitable for use with the safety notification device of FIG. 1.

FIG. 7 is a flow chart of a method of generating an alert with the safety notification device of FIG. 1.

### DETAILED DESCRIPTION

The present disclosure describes a safety notification or a safety alert device and methods adapted to actively identify risks to people, such as pedestrians or other target persons, of possible collisions with vehicles and generate alerts that are understandable by both targets and persons operating vehicles.

In many embodiments, the safety alert device includes a housing with one or more notification or active alert components, such as lights or speakers. The alert components are configured to alert a driver and/or a target of a possible collision risk. The alerts may be activated based on an assessment of likelihood of collision, rather than at mere presence of a driver or moving vehicle, this helps to ensure that the alerts will be noticeable and infrequent, so as to not fade into the background as noise. In some embodiments, the alert type or output may vary based on the likelihood of collision, e.g., become more intense as the likelihood increases.

The safety alert device may include a head unit removably coupled to the housing, where the head unit may include a circuit assembly and one or more sensors, speakers, and/or actuators electrically connected to the circuit assembly. The removability of the head unit allows the head unit to be separately serviced (e.g., mailed in for repair, replaced for upgrade) from the remaining portion of the housing, such as a base.

In many embodiments, the safety alert device includes a warning indicia encouraging drivers to drive slowly or be alert for targets, e.g., SLOW positioned on front and rear surfaces of the housing. The warning indicia or other passive alerts may alert also a driver to the presence of a target in the vicinity of the safety alert device, e.g., CHILDREN PLAYING.

To activate the active alert(s), the safety alert device may capture image data of an environment around the device, such as a risk area (e.g., street) and adjacent or “safer” areas (e.g., a sidewalk or yard). The safety alert device may establish a scene from the received image data and identify a region of interest based on the image data where collisions between vehicles and targets may be likely, e.g., the street or other area where vehicles may typically travel. The safety alert device may also identify a safe region, such as a region not forming the interest region, where the safe region is an area where collisions are unlikely to occur, e.g., a front yard, a park, or playground. The safety alert device may also identify an intermediate region in the scene, where collisions may be likely to occur, but to a lesser extent than in the region of interest and to a higher extent than in the safe region, e.g., a sidewalk or a shoulder of a road. Utilizing the various areas of the scene, the safety alert device can monitor movement within the scene to determine if a collision between a target and a vehicle is likely. For example, the safety alert device may track motion and analyze trajectory, speed, and the like, to make predictions regarding collisions and then generate active alerts based on the same. Such “smart” alerts, help to increase the alert functionality for drivers and/or targets, without over saturating the environment with noise that could detract from the effectiveness of the alert. Also, by having dual alerts (e.g., passive and active) the device may act as a light warning or alert for low risk movement, but enhance the output as the movement becomes riskier.

As used herein a target is meant to encompass persons using or positioned within a risk area or a safer area adjacent to the risk area (e.g., a sidewalk, yard, etc.). A target may be a person walking on a sidewalk near a road, a person playing in a front yard of a house near a road, person playing in an alleyway behind a house, or the like. A risk area typically encompasses those areas generally used by vehicles, such as a road, street, parking lot, alleyway, trail, ski or snow mobile run, body of water, or the like. The term vehicle encompasses a device that moves along the driving area, such as a car, truck, van, bus, golf cart, motorcycle, bicycle, scooter, roller skates, skateboard, snowmobile, skis, snowboard, tractor, boat, personal watercraft, a horse, or the like. A vehicle may be powered, such as by an engine, electric motor or the like. A vehicle may also be an unpowered vehicle, such as a skateboard, scooter, or similar vehicle. A driver may generally encompass an operator of a vehicle, e.g., person driving a car, steering a boat, riding a scooter. In some instances, a target, as used herein can also be a driver. For example, a child riding a scooter along a roadway is a driver of the scooter, but may be a target at risk from a collision from a larger or faster vehicle such as a car, bike, motorcycle, or the like.

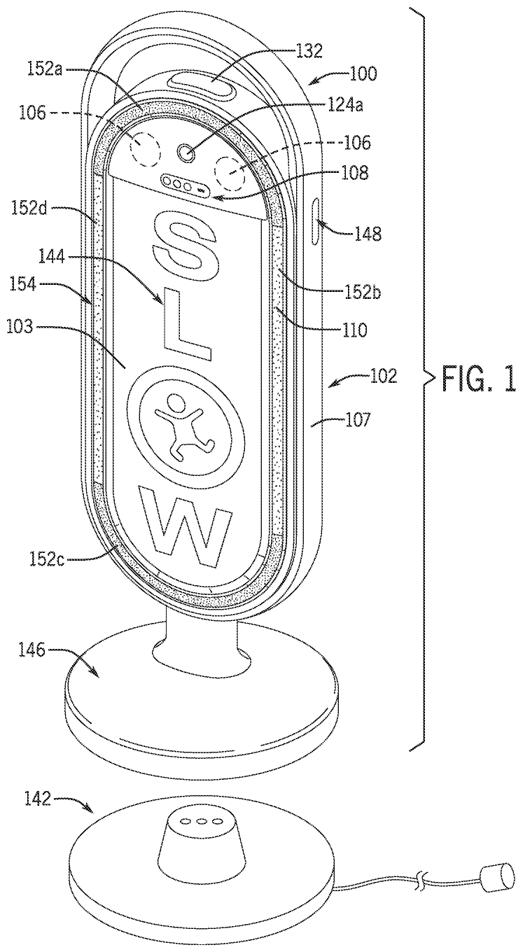

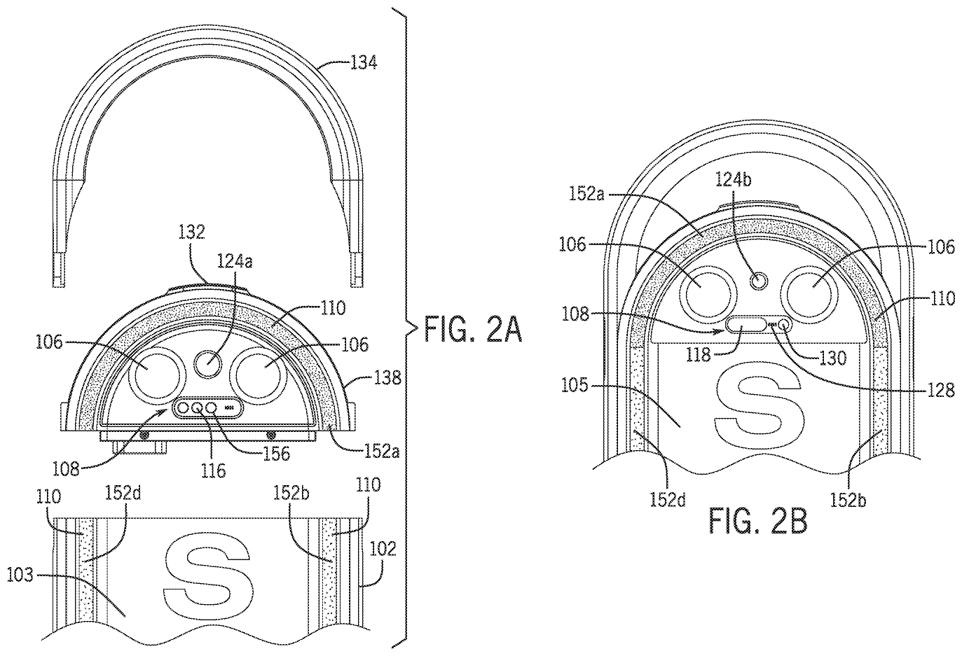

With reference to FIGS. 1-2B, an embodiment of a safety alert device 100 is shown. The safety alert device 100 includes a housing 102, which may act as a support structure and house various components of the safety alert device 100. The housing 102 may be coupled to a head 138, a handle 134, and/or a base 146. The safety alert device 100 includes an alert assembly 112 that notifies a target and/or driver of the likelihood of a collision therebetween. The alert assembly 112 may include one or more alert components, such as a visual alert (e.g., lighting assemblies 110) and/or one or more audio outputs 106 (e.g., speakers). In many embodiments, the head 138 may contain portions of the alert assembly 112, sensors (e.g., one or more light sensors 116, audio sensors 156), actuators, or the like. In many embodiments, the housing 102 may contain a power supply 126 such as a battery, alternating current (“AC”) power adapter, or the like to provide power to the safety alert device 100.

The safety alert device 100 may have opposing broad faces 103, 105 that are joined to one another by a relatively narrower edge 107. The edge 107 may surround a periphery of the respective faces 103, 105. In some embodiments, the faces 103, 105 may be substantially planar. The faces 103, 105 may be a front and back of the safety alert device 100. One or both of the faces 103, 105 and/or edge 107 may include or expose the warning indicia 144, the alert assembly 112, or the like. The edge 107 may be rounded such as to smoothly join the faces 103, 105. The faces 103, 105 may have any shape and/or size that can support or include the warning indicia 144 and/or lighting assembly 110 so as to be viewable by a driver in the risk area. For example, the faces 103, 105 may be shaped such that the housing 102 defines an oval, aesthetically appealing shape with front and rear surfaces 103, 105 that are oriented in a plane perpendicular to the street such as to be visible to drivers when positioned on the risk area or sidewalk. In another example, the faces 103, 105 may form a triangle, octagon, square, other polygon, or an irregular shape. The housing 102 and the head 138 may form respective portions of one or more of the faces 103, 105 such that when the head 138 is assembled with the housing 102, the head 138 and the housing 102 form unified faces 103, 105. Similarly, the housing 102, head 138, and/or handle 134 may form respective portions of the edge 107, such that when the head 138 and handle 134 are assembled with the housing 102, the head 138, the handle 134, and the housing 102 form a unified edge 107.

Either or both of the faces 103, 105 may include, or have coupled thereto, one or more of the warning indicia 144 and/or a lighting assembly 110. For example, each of the faces 103, 105 may have coupled thereto respective warning indicia 144 and lighting assemblies 110 such that the safety alert device 100 can provide alerts in both directions, and possible collisions and the like can be identified regardless of the side of the safety alert device 100 a vehicle and/or target is situated. Additionally, the safety alert device 100 may include image capture devices coupled to each of the faces 103, 105.

The housing 102 may include a warning indicia 144, such as words, numbers, icons, graphics, letters, or other symbols. The warning indicia 144 may be configured as a passive alert and indicate that a person, such as a driver, should exercise caution in the vicinity of the safety alert device 100. For example, the warning indicia 144 may include the words “SLOW”, “CHILD AT PLAY”, “DANGER”, “CAUTION”, “SLOW DOWN”, “DEAF PERSON”, “BLIND PERSON” or the like. The warning indicia 144 may include a symbol such as an icon representing a child running, a warning triangle, or other such symbol. The warning indicia may be printed, stenciled, etched, embossed, adhered, or formed with the housing 102.

The handle 134 may be suitable to be grasped by a user such that the safety alert device 100 may be moved. For example, the safety alert device 100 may weigh approximately 10 pounds such that the device may be easily lifted via the handle 134 by a user and placed in an appropriate location. The handle 134 may extend above a top end wall of the head 138 and define a space therebetween, e.g., to receive a person's hand. As discussed, head 138 and/or handle may form a portion of the edge 107. For example, the handle 134 may complete the outer periphery of the edge 107 of the safety alert device 100 when coupled to the head 138 and the housing 102. The handle 134 may protect the head 138 in the event of the safety alert device 100 tipping over (such as by the effects of wind, an impact with a vehicle, person, or the like). For example, the handle 134 and the base 146 may provide impact points for the safety alert device 100 in the event it is tipped, such that the actuators, controls, I/O interface 108, sensors, lighting assembly 110, etc. do not impact the ground.

The base 146 may be configured to stably support the safety alert device 100 in a variety of conditions, such as wind or uneven/sloped terrain. For example, the base 146 may be a wide, flared, round portion. In some embodiments, the base may include, or be configured to receive, ballast material or provide additional stability. For example, the base may be fillable with water, sand, or other suitable heavy material to further stabilize the safety alert device 100. An advantage of the base 146 being fillable with a ballast material is that the safety alert device 100 may be shipped without the ballast, thus reducing shipping costs, while a user can easily add a readily available and low cost ballast after receiving the safety alert device 100.

In some embodiments, the base 146 may be configured to be coupled with a charger 142. For example, as shown in FIG. 1, the charger 142 may be configured to receive the base 146. The charger 142 may be electrically couplable to a power supply such as AC power. The charger 142 and the base 146 may include complementary electrical contacts, such that when the safety alert device 100 is placed on the charger 142, the charger 142 charges the power supply 126 of the safety alert device 100, such as a battery.

The head 138 may include certain components of the safety alert device 100 such as electronic circuitry, energy storage, sensors, lights, speakers, user inputs, or the like. For example, the head 138 may include a portion (e.g., a first portion 152a) of the lighting assembly 110. The head 138 may include one or more audio output components 106. The head 138 may include one or more image capture devices 124. For example, the head 138 may include a first image capture device 124a on a first side (e.g., the front) and another image capture device 124b on a second side opposite the first side (e.g., the back), where the two image capture devices may capture different portions of the environment, where the respective fields of view of the image capture devices 124a,b may be overlapping or may not overlap. The head 138 may include a user input 132 suitable to activate features or processes of the safety alert device 100. The head 138 may include an input/output (“I/O”) interface 108. The I/O interface 108 may include a light sensor 116, a wired interface 118, a status indicator 128, a power button 130 or other suitable input/output devices such as buttons and/or lights. Portions of the I/O interface 108 may be disposed on different parts of the safety alert device 100. For example as shown in FIG. 2A, the I/O interface 108 may include a light sensor 116 on the front of the safety alert device 100. Also as shown for example in FIG. 2B, the I/O interface 108 may include the wired interface 118, the status indicator 128, and/or the power button 130 on the rear of the safety alert device 100. The devices of the I/O interface 108 may be distributed to other portions of the safety alert device 100 as desired. The head 138 may be sealed against the ingress of environmental contaminants such as wind, rain, dirt, insects, air pollution, or the like.

Various components of the safety alert device 100 may be disposed in the housing 102, such as one or more portions 152 of a lighting assembly 110, a power supply 126 such as a battery, or the like. The power supply 126 may be disposed in a sealed compartment in the housing 102 such as to reduce or prevent contamination of the power supply 126 from environmental debris and fluid. In some embodiments, the housing 102 may be open or ventilated, such as to exhaust heat generated by the lighting assembly 110. An advantage of placing the power supply 126 in the base 146 may be that the center of gravity of the safety alert device 100 is lower to the ground than if the power supply 126 were placed in the head 138. A lower center of gravity may help improve the stability of the safety alert device 100 compared to a higher center of gravity.

The head 138 and/or the handle 134 may be removable from the housing 102. See, e.g., FIG. 2A. The handle 134 may include a locking mechanism 148 that when activated, such as by pushing, the handle 134 may unlock from the housing 102 and the handle 134 may be removed from the housing 102. The handle 134 may secure the head 138 to the housing 102, such that when the handle 134 is removed, the head 138 may be removed from the housing 102. The head 138 and the housing 102 may include complementary electrical connectors that provide an electrical connection between one or more components in the head 138 and one or more components in the housing 102. The connector may automatically align electrical contacts in the head 138 with corresponding electrical contacts in the housing 102. For example, the connector may include protrusions and/or recesses that mate with complementary protrusions and/or recesses in the housing 102, such that the respective protrusions/recesses align the electrical contacts between the head 138 and housing 102. Thus, the connector and electrical contacts may provide an electrical connection (e.g., power and/or signals) between the components in the head 138 and the components in the housing 102.

An advantage of a removable head and placing many of the components of the safety alert device 100 in the head 138 with the power supply 126 in the housing 102, may be that the head 138 can be shipped or serviced without the concerns associated with shipping batteries, as well as without requiring that the entire device be shipped or delivered to a repair facility. Such shipping may be helpful for warranty service and/or upgrades of the head 138. For example, a user may detach a head 138 and return it to the manufacturer in exchange for a functioning and/or upgraded head 138 that can be easily integrated with the safety alert device 100.

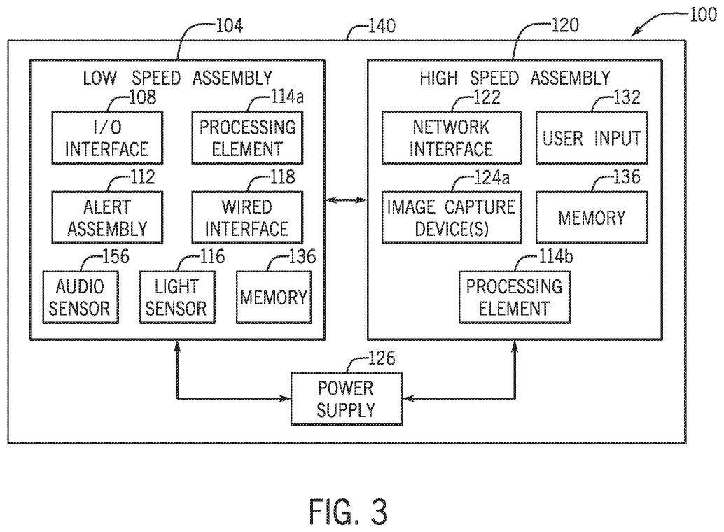

One or more of the lighting assemblies 110 and/or portions 152 of a lighting assembly 110 may be incorporated with the housing 102 and/or head 138. A lighting assembly 110 may be coupled the housing 102 and may be viewable from any surface of the housing 102, such as the face 103, 105 and/or the edge 107. For example, lighting assemblies 110 may be coupled to on the faces 103, 105 of the housing 102 and/or head 138 (see, e.g., FIG. 2A and FIG. 3). The lighting assemblies 110 may be any light source suitable to emit light that can be seen by a driver and/or a target in the risk area or an adjacent area. For example, the lighting assemblies 110 may include light emitting diodes (“LED”), incandescent lamps, strobes, halogen lights, or the like.

In many embodiments, the lighting assembly 110 may surround the warning indicia 144. For example, the lighting assembly 110 may extend around the perimeter of one or more of the faces 103, 105. The lighting assembly 110 may thus generally conform to the shape of the housing 102. In some embodiments, the lighting assembly 110 may be concentric with the warning indicia 144. For example, as shown in FIG. 1, the lighting assembly 110 may form an oval shape that surrounds the warning indicia 144. The lighting assembly 110 may be formed of two or more separate portions. For example, the lighting assembly 110 may have a first portion 152a, a second portion 152b, a third portion 152c, and a fourth portion 152d. Any of the portions 152 may include one or more light sources. For example, a portion 152 may include one or more LEDs or other light sources. The portions 152 of the lighting assembly 110 may be sealed against the ingress of environmental contaminants.

Any of the portions 152 of the lighting assembly 110 may include a lens element 154 disposed between a light source and the environment. A lens element 154 may modify, focus, bend, or redirect the light emitted from a light source. In one embodiment, the lens element 154 is a total internal reflector element. The total internal reflector element may focus light emitted by a light source within a portion 152. For example, the lens element 154 may direct the light to an angle from a line normal to the lens, such as 5°, 7.5°, 10°, 12°, 15°, 20° or more to each side of the normal line. An advantage of directing the light output may be that the light intensity is concentrated to better capture the attention of drivers and/or targets. For example, the lights sources in the lighting assembly 110 may be sufficiently bright to be seen at 100 m, 150 m, 200 m, or more, in daylight conditions.

The light sources may emit any color of light. In some embodiments, the light sources may be configurable so as to emit a desired color. For example, a light source may include a substantially red, green, and blue element, where the intensity of light emitted by each element is adjustable such that the emitted light from the light source is a blend of the emissions with a desired color. In many embodiments, the lights sources of the lighting assembly 110 may emit a fixed range of wavelengths. For example, the lighting assembly 110 may emit a substantially white or amber light.

The intensity of a light source may be configurable. For example, a light source intensity and/or hue may be automatically set (e.g., by a processing element) based on ambient lighting conditions (such as detected by the light sensor 116) or other factors. For example, in bright daylight, a light source intensity may be increased or set to a high level so as to make the lighting assembly 110 more visible. In another example, a hue of the light may be changed to contrast with ambient lighting conditions. For example, during a sunrise and/or sunset, the color of the ambient light is frequently a “warm” color such as yellow, orange, red or the like. In such conditions, the hue of the light emitted by the lighting assembly 110 may be configured to a “cool” color such as white, blue, violet or the like to contrast with the color of the sunset. In another example, the light source intensity may be decreased in evening or dusk settings so as to reduce the risk of blinding or overly distracting drivers. In some examples, a light sensor 116 may be disposed on two portions of the safety alert device 100 such as a front and back. In such embodiments, the light sensors 116 may be adapted to detect backlight conditions (e.g., sunrise and/or sunset). In a backlight condition, the intensity of the light emitted by a lighting assembly 110 on one part of the safety alert device 100 may be set to a different intensity than a lighting assembly 110 on another portion of the safety alert device 100. For example, the lighting assembly 110 on a side of the safety alert device 100 facing away from a sunset may have its intensity increased so as to be more visible to drivers who may be looking into the sunset. The lighting assembly 110 on the side facing into the sunset may be set at a lower intensity than the lighting assembly 110 on the side facing away from the sunset so as to avoid blinding drivers looking away from the sunset. Adjusting the intensity of the light sources may have a benefit of conserving power, which may be particularly important when the power supply 126 is a battery.

When the head 138 is assembled with the housing 102, the first portion 152a of the lighting assembly 110 associated with the head 138 may align with a second portion 152b and/or a fourth portion 152d of the lighting assembly 110 associated with the housing 102 such that the lighting assembly 110 forms a unified structure. The portions 152a-d of a lighting assembly 110 may together form a shape or symbol. For example, the first portion 152a and the third portion 152c may be arcuate in shape and the second portion 152b and fourth portion 152d may be linear in shape. The portions 152a-d may together form an oval. The lighting assembly 110 may form other suitable shapes such as polygons like rectangles, squares, triangles, or irregular shapes. In some embodiments, the lighting assemblies 110 may illuminate all or a portion of the warning indicia 144. For example, the lighting assemblies 110 may include lighted letters, numbers, words, or symbols.

In some embodiments, portions 152 of the lighting assembly 110 may be daisy chained to one another. For example, power may be provided to the first portion 152a of the lighting assembly 110 and the first portion 152a provides power to a second portion 152b of the lighting assembly 110. The second portion of the lighting assembly 110 may supply power to a third portion 152c of the lighting assembly 110, and so on. In some embodiments, a control signal may be supplied in a daisy chain fashion similar to the power. Thus, the lighting assembly 110 may be controlled by a three wire scheme that provides power and a control signal to the lighting assembly 110. The control signal may be operative to address and control individual portions 152 and/or individual light sources within a portion 152 of the lighting assembly 110. The control signal may control the intensity and/or color of the light emitted. Animation, lighting sequences, patterns, and/or motion effects may be created by the controlled timing of illumination of the portions 152 and/or individual light sources within the portions 152.

With reference to FIG. 3, a circuit assembly 140 of the safety alert device 100 is disclosed. The circuit assembly 140 may include a low speed assembly 104 and a high speed assembly 120. The low speed assembly 104 and the high speed assembly 120 may execute certain functions for which each assembly is preferentially adapted. For example, certain functions are lower priority or use fewer computing resources and may be preferentially executed by the low speed assembly 104. In another example, certain functions are higher priority and/or use more computing resources and may be preferentially executed by the high speed assembly 120. A benefit of using a low speed assembly 104 and a high speed assembly 120 may be that each alert assembly 112 can be optimized for its intended purpose. For example, the low speed assembly 104 and high speed assembly 120 may include relatively simple 2-layer printed circuit boards, whereas incorporating the low speed assembly 104 and the high speed assembly 120 into a single board, a more complex and expensive eight layer board may be used.

In some embodiments, the power supply 126 provides power to both the low speed assembly 104 and the high speed assembly 120. In some embodiments, the safety alert device 100 includes separate power supplies 126 for the low speed assembly 104 and the high speed assembly 120.

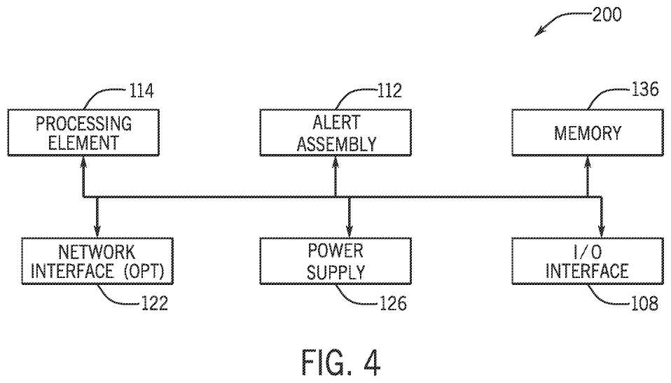

In one embodiment, the low speed assembly 104 includes a processing element 114a, memory 136, the I/O interface 108, a portion of the alert assembly 112, the wired interface 118, one or more audio sensors 156, and/or the light sensor 116. The processing element 114 may be in electrical communication with any of the components of the low speed assembly 104 such as via system buses, contract traces, wiring, or via wireless mechanisms. The processing element 114a and memory 136 may be any respective devices such as described with respect to FIG. 4. In some embodiments, the processing element 114a in the low speed assembly 104 is a low power or low speed processor.

The I/O interface 108 allows the safety alert device 100 components to receive input from a user and provide output to a user. The I/O interface 108 may include a status indicator 128 such as an LED or other suitable light that indicates a status of the safety alert device 100, such as an energy level of the power supply 126, network connectivity, activation of an audio sensor 156, or the like. The I/O interface 108 may include a power button 130 suitable to turn the safety alert device 100 on or off. For example, the input/output interface 108 may include a capacitive touch screen, keyboard, mouse, stylus, button, light, or the like. The type of devices that interact via the input/output interface 140 may be varied as desired. The I/O interface 108 may be optional.

The alert assembly 112 may include one or more of the lighting assemblies 110 or portions 152 thereof. The alert assembly 112 may include one or more audio outputs 106. The audio outputs 106 may be speakers, sirens, claxons, or the like. In some embodiments, an audio output component 106 includes an amplifier such as a passive radiator that amplifies sound generated by the audio output component 106. For example, the passive radiator may include a flexible membrane made of a resilient material such as an elastomer.

The wired interface 118 may be suitable to accept a removable memory 136 device such as an SD or micro SD card or other storage device. The removable memory 136 may be suitable to record images, sounds, video, and/or events detected or generated by the safety alert device 100.

The one or more audio sensors 156 may be adapted to detect sounds in the vicinity of the safety alert device 100. In some embodiments, an audio sensor is adapted to detect a human voice such that the safety alert device 100 can receive spoken communications and/or commands from a user. In some embodiments, an audio sensor 156 may be adapted to detect ambient noise levels. In some embodiments, the safety alert device 100 may include both a first audio sensor 156 adapted to detect the human voice and a second audio sensor 156 adapted to detect ambient noise. A benefit of using two audio sensors 156 may be that the safety alert device 100 may automatically adjust the output volume of an audio output component 106 and/or the sensitivity of an audio sensor 156 adapted to detect a human voice in response to ambient noise. For example, as ambient noise increases (e.g., from traffic) the output volume of an audio output component 106 may increase. Likewise the sensitivity or gain of an audio sensor 156 may be increased to better distinguish a human voice over the noise. Similarly, as noise decreases, the volume of an audio output component 106 and/or sensitivity of an audio sensor 156 may decrease.

The light sensor 116 may be adapted to detect ambient or directed light in the vicinity of the safety alert device 100. For example, a light sensor 116 may be a photo resistor such as a cadmium sulfide (“CdS”) photocell, a photodiode, and/or a phototransistor. In some examples, an electrical signal generated by a light sensor 116 is a signal that becomes more intense the greater the light output detected by the light sensor 116. In some examples, an electrical signal generated by a light sensor 116 is a signal that becomes less intense the greater the light output detected by the light sensor 116 (e.g., a CdS photo cell whose resistance increases with light output detected). In some embodiments, the light sensor 116 generates a digital signal that increases or decreases with the light detected. In some embodiments, the image capture device 124a,b may be used as or include a light sensor 116. For example an image capture device 124 may include a sensor such as a complementary metal oxide semiconductor (“CMOS”) or charge-coupled device (“CCD”) sensor that can detect an ambient light level. In some embodiments an image capture device may be configurable in a first mode to capture an image and a second mode to detect an ambient light level. The image capture device 124 may be switched between the first and second modes, such as by a processing element 114. In one example, the image capture device 124 may be primarily operated in the first mode and may be switched periodically to the second mode to capture an ambient light level.

In one embodiment, the high speed assembly 120 may include a network interface 122, processing element 114, memory 136, the user input 132, and/or the image capture devices 124a,b. The network interface 122, processing element 114b, and memory 136 may be any respective devices such as described with respect to FIG. 4. In some embodiments, the processing element 114b is a higher power and/or higher speed processor relative to the processing element 114a in the low speed assembly 104. For example, the processing element 114b may be an artificial intelligence (“AI”) accelerator or the like. For example, the processing element 114b may be a tensor processing unit, graphics processing unit, or the like. The high speed assembly 120 may include one or more additional processing elements 114 with the processing element 114b.

The user input 132 is any device adapted to receive an input from a user, such as a button or switch. The user input 132 may be adapted to activate one or more functions of the safety alert device 100. For example, the user input 132 may activate a request for help, initiate a communications session between the safety alert device 100 and another device, such as push to talk, or walkie-talkie function, video chat, or the like.

The image capture devices 124a,b may be any suitable device adapted to capture image data. For example, an image capture device 124a may include an image sensor and a lens element that focuses or directs light to the image sensor. The image capture devices 124a,b may be still or video cameras. The image capture devices 124a,b may be adapted to adjust to a variety of lighting conditions such as dawn/dusk, daylight, and/or night time. The high speed assembly 120 may include an optional switch that selectively, electrically connects the image capture devices 124a or the image capture device 124b to a processing element 114. An advantage of using a switch may be that a lower power or lower cost processing element 114 may be used that has inputs for one image capture device 124 rather than two image capture devices 124. The switch can selectively activate one or the other of the image capture device 124a or 124b as desired. For example, an appropriate image capture device 124 may be activated based on detected motion. The image capture devices 124a,b may detect visible light as well as light that is not usually visible to the human eye, such as infrared and/or ultraviolet light. In some embodiments, an image capture device 124 may be a light detection and ranging (“LIDAR”) and/or radio detection and ranging device (“RADAR”).

FIG. 4 illustrates a simplified block diagram for the various devices of the safety alert device 100 such as the low speed assembly 104 and the high speed assembly 120, and a user device 502. As shown, the various devices may include one or more processing elements 114, a lighting assembly 110, one or more memory 136, an optional network interface 122, optional power supply 126, and an optional input/output I/O interface 108, where the various components may be in direct or indirect communication with one another, such as via one or more system buses, contract traces, wiring, or via wireless mechanisms.

The one or more processing elements 114 may be substantially any electronic device capable of processing, receiving, and/or transmitting instructions. For example, the processing elements 114 may be a microprocessor, microcomputer, graphics processing unit, tensor processing unit, or the like. It also should be noted that the processing elements 114 may include one or more processing elements or modules that may or may not be in communication with one another. For example, a first processing element may control a first set of components of the computing device and a second processing element may control a second set of components of the computing device where the first and second processing elements may or may not be in communication with each other. Relatedly, the processing elements may be configured to execute one or more instructions in parallel locally, and/or across the network, such as through cloud computing resources. One or more processing elements 114 such as a tensor processing unit may be an edge device adapted to execute an artificial intelligence (“AI”) algorithm such as an artificial neural network (“ANN”). Performing AI calculations on the processing element 114 may have certain benefits over performing such calculations on a remoted device such as a server. For example, by performing calculations locally, delays or outages due to lack of network connectivity between the safety alert device 100 and a server can be avoided. Further, results of AI calculations may be more quickly available when performed locally. However, in some embodiments, AI or other calculations may be executed by a processing element 114 in a server in communication with the safety alert device 100.

The memory 136 is a computer-readable storage medium that stores electronic data that may be utilized by the computing devices, such as audio files, video files, document files, programming instructions, image data, models of the scene 518, and the like. The memory 136 may be, for example, non-volatile or non-transitory storage, a magnetic storage medium, optical storage medium, magneto-optical storage medium, read only memory, random access memory, erasable programmable memory, flash memory, or a combination of one or more types of memory components.

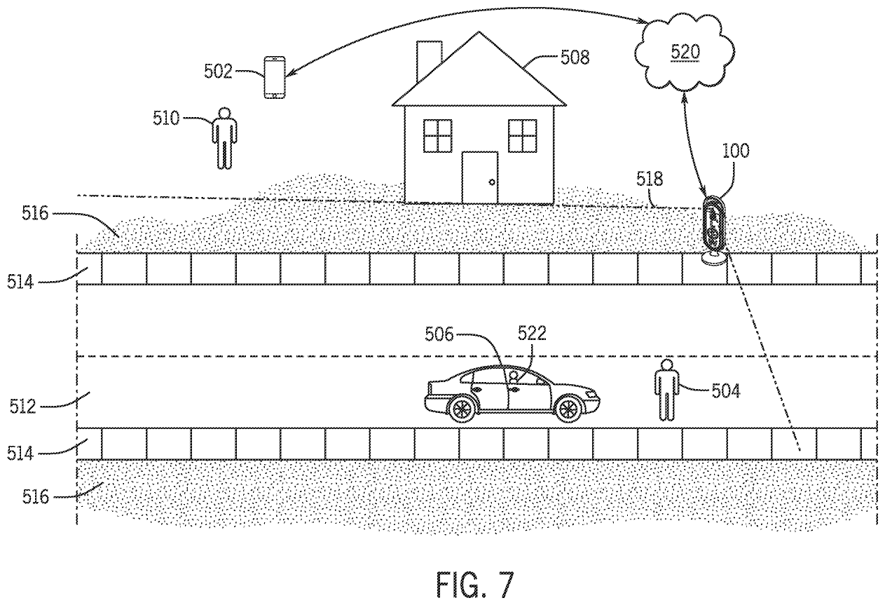

The optional network interface 122 receives and transmits data to and from a network 520 to the various devices of the safety alert device 100. The network interface 122 may transmit and send data to a network 520 (see, e.g., FIG. 7) directly or indirectly. For example, the network interface 122 may transmit data to and from other computing devices through the network interface 122. In some embodiments, the network interface 122 may also include various modules, such as an application program interface (API) that interfaces and translates requests across the network interface 122 between the user device 502 and the safety alert device 100. The network interface 122 may be any suitable wired or wireless interface. For example, the network 520 may be an Ethernet network, Wi-Fi, Bluetooth, Wi-Max, Zigbee network, the internet, microwave link, cellular network (e.g., 3G, 4G, 5G), or the like.

The various devices of the safety alert device 100 may also include a power supply 126. The power supply 126 provides power to various components of the user device 502 or safety alert device 100. The power supply 126 may include one or more rechargeable, disposable, or hardwire sources, e.g., batteries, power cord, AC/DC inverter, DC/DC converter, solar panel, or the like. Additionally, the power supply 126 may include one or more types of connectors or components that provide different types of power to the user device 502, the safety alert device 100, the low speed assembly 104, and/or the high speed assembly 120. In some embodiments, the power supply 126 may include a connector (such as a universal serial bus) that provides power to the computer or batteries within the computer and also transmits data to and from the device to other devices.

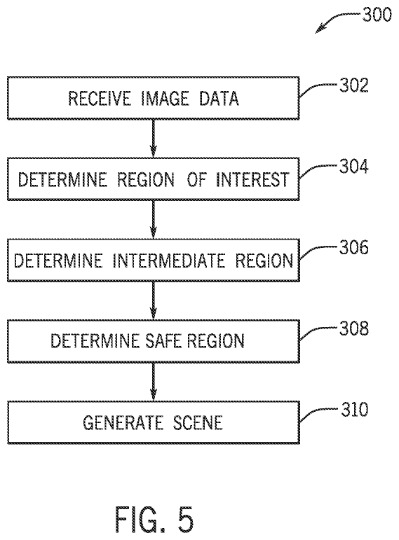

With reference to FIGS. 5 and 7, a method 300 of establishing a scene 518 with the safety alert device 100 is disclosed. The method 300 may begin in operation 302 and a processing element 114 receives image data. The image data may be received by the processing element 114a, the processing element 114b, or another processing element 114. The image data may be generated by one or more of the image capture devices 124a,b. The image data may include a portion of a driving area and/or adjacent areas.

The method 300 may proceed to operation 304 and a processing element 114 determines a region of interest 512. As discussed herein, the region of interest 512 may be a road, trail, driveway, alley, garage, or other risk area where a collision between a moving object 506 and a target 504 is likely.

The method 300 may proceed to operation 306 and a processing element 114 determines an intermediate region 514. As discussed herein, an intermediate region 514 may be a region near a region of interest where a target is present or where there may be an increased likelihood of a target approaching the region of interest. In some embodiments, the region of interest may be a region where a collision between a moving object 506 and a target 504 may be likely to occur, but less likely than in the region of interest 512, such as a sidewalk, a road shoulder or the like.

The method 300 may proceed to the operation 308 and a processing element 114 determines a safe region 516. As discussed herein, the safe region 516 may be a region where a collision between a moving object 506 and a target 504 is unlikely, such as in a yard, a playground, a building 508, or the like. In some implementations, the intermediate region may be located between the region of interest and the safe region.

The method 300 may proceed to operation 310 and a processing element 114 generates the scene 518 including the region of interest 512, intermediate region 514, and/or safe region 516. The scene 518 may be stored in a memory 136 of the safety alert device 100. In some embodiments, the scene 518 may be automatically re-established based on a prior scene 518, such as after the safety alert device 100 is righted after being tipped over.

In some implementations, the region of interest 512, the intermediate region 514, and/or the safe region 516 may be determined based on features in the image data such as lines, corners, points, or surfaces. In some implementations the regions may be determined based on colors (e.g., pavement is often dark gray or black, sidewalks are often light gray, and grass is often green). In some implementations, the region of interest 512, the intermediate region 514, and/or the safe region 516 may be determined by an AI algorithm such as an ANN executed on the processing element 114b. The AI algorithm may have been trained on a training data set of image data where the various examples of a region of interest 512, intermediate region 514, and/or safe region 516 have been previously identified. In some implementations the region of interest 512, intermediate region 514, and/or safe region 516 may be determined manually or may be adjusted manually by a user.

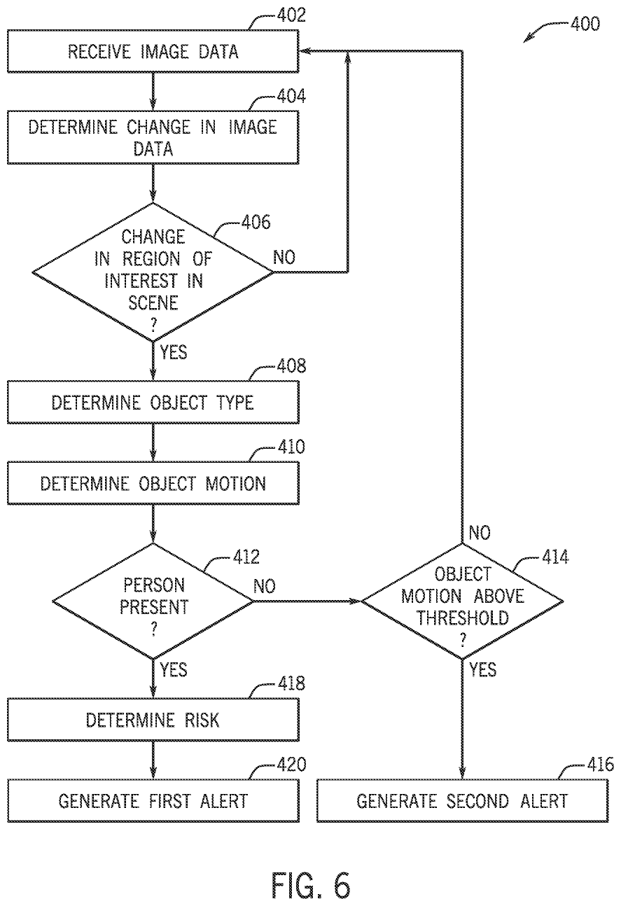

With reference to FIGS. 6 and 7, a method 400 of determining a risk to a target 504 and alerting the target 504 is disclosed. The method 400 may begin in the operation 402 and a processing element 114 receives image data, as previously discussed with respect to the operation 302.

The method 400 may proceed to the operation 404 and a processing element 114 determines a change in the image data. For example, the image data may include still images of the scene 518 over time, such as successive frames of video captured by one or more of the image capture device 124a and/or the image capture device 124b. For example, a processing element 114 may perform a pixel comparison of successive frames of image data to determine whether any of the pixels have changed, or whether groups of pixels between successive images are similar to one another. For example, the processing element 114 may subtract the pixels in one frame from those in another frame such that similar or identical pixels are removed. The remaining pixels may represent a moving object. For example, pixels of successive images may change if a target 504 and/or a moving object 506 is moving in the scene 518.

The method 400 may proceed to operation 406 and a processing element 114 determines whether the image data has changed. If the image data has changed, the processing element 114 may determine whether the change is within the region of interest 512. If the image data has not changed or the change is not in the region of interest 512, the method 400 may return to the operation 402. If a detected change is in the region of interest 512, the method 400 may proceed to the operation 408.

In the operation 408, a processing element 114 determines whether the change is associated with a moving object 506 such as a vehicle and/or such as a target 504. In the operation 408 a processing element 114 detects the type of object. For example, it may be desirable to discriminate between targets 504, moving objects 506, birds, dogs, moving clouds, blowing garbage, an airplane flying overhead, or the like. To determine the object type, the processing element 114 may execute an AI algorithm such as an ANN trained to classify objects. In many embodiments, the AI algorithm may be executed by the processing element 114b, which as discussed, may be adapted to execute such algorithms efficiently. In some examples, a moving object 506 may be detected due to the object changing size in the image data (e.g., becoming larger or smaller due to changes in its distance from the image capture device 124), while the aspect ratio of the object remains the same. In another example, an object may be determined to be a target 504 by detecting skeletal features of the object. In some examples, an object type may be determine based on its size. For example, a car is usually larger than a person.

The processing element 114 may generate a confidence level that a detected object is of a certain classification. For example, the processing element 114 may determine that an object is a child with an 80% confidence, or that a moving object 506 is a car with 90% confidence. If the confidence that an object falls within a certain classification is below an object detection threshold, the object may be ignored and the method 400 may return to the operation 402. For example, when the confidence that an object is a child is only 20%, the processing element 114 may ignore the object. The object detection threshold may be configurable, such that the safety alert device 100 can be tuned to various sensitivity settings. For example, the object detection threshold or ranges of object detection thresholds may correspond to one or more user-configurable settings. For example, a user-configurable setting may cause the device 100 to be more or less aggressive in detecting objects. For example, a user may want to configure a setting so an object detection threshold is such that the safety alert device 100 errs on the safe side of detecting an object. In such an example, a 20% confidence or lower that a detected object is a child may be sufficient to proceed with the method 400. Similarly, parents of older children may desire that the safety alert device 100 is more discriminatory about generating alerts and set the object detection threshold to a higher level such as 80, 85, or 90%.

In some implementations of the operation 408, the processing element 114 may record the type of object detected to a log stored in memory 136. Such a feature may be useful for instance on a residential street where many of the moving objects 506 that drive on the street are associated with houses along the street and may be encountered frequently. Logging detected objects such as vehicles may enable faster subsequent detection, and/or the modification of alerts (discussed with respect to the operation 420 below) based on a particular vehicle detected. Logged data may include descriptive data of the object such as color, make, model of car, license plate, a face of a driver 522, etc. For example, if a teenager lives on a street and frequently speeds down the street, data related to the teenager's vehicle may be stored such that the safety alert device 100 can generate more aggressive alerts when the teenager's vehicle is subsequently detected.

If an object is determined to be an object not of interest, such as garbage or an airplane, the processing element 114 may ignore the object and the operation 408 may return to the operation 402. If the object is determined to be an object of interest such as a moving object 506 and/or is detected with a confidence at or above the object detection threshold, such as a moving object 506 or target 504, the method 400 may proceed to the operation 410.

In the operation 410, the processing element 114 may determine one or more characteristics of the motion of the object. For example, the processing element 114 may determine a position, trajectory, speed, direction, velocity (i.e., speed and direction), and/or acceleration of the object. The processing element 114 may determine whether the object is moving toward, away from, or within any of the region of interest 512, the intermediate region 514, and/or the safe region 516 in the scene 518. Detecting skeletal characteristics of a person (e.g., in the operation 408) may be beneficial to determine the person's motion. For example, a processing element 114 adapted to understand the biomechanics of a human body may, with skeletal characteristics, determine if the person is running, walking, standing, or the like, and in what direction the person is moving, or likely may move. Additionally or alternately, the age of the person may be determined from skeletal data. Age determination may be useful to tune the intensity of an alert. For example, an alert may be less intense if the person detected is an adult and more intense if the person is a child.

The method 400 may proceed to the operation 412 and a processing element 114 determines whether an object type detected in the operation 408 includes a person. If a person is not detected, the method 400 may proceed to the operation 414. If a person is detected, the method 400 may proceed to the operation 418.

In the operation 414, a processing element 114 determines whether the object motion determined in the operation 410 is above an object motion threshold. For example, the processing element 114 may determine whether the object is moving at a speed above the speed limit of the street. Additionally, the processing element 114 may determine whether the object is accelerating or the like. If the object motion is below the object motion threshold, the method 400 may return to the operation 402. If the object motion is above the object motion threshold, the method 400 may proceed to the operation 416. As with the object detection threshold, the object motion threshold may be configurable. For example, the object motion threshold or ranges of object motion thresholds may correspond to one or more user-configurable settings. For example, a user-configurable setting may cause the device 100 to be more or less aggressive in detecting object motion. For example, a user-configurable setting may determine how close in time (e.g., feet) and/or space (e.g., seconds) a target and vehicle are from a collision.

In the operation 418, a processing element 114 may determine a risk to the target 504 of the detected moving object 506. The processing element 114 may determine, based on the object motion of the moving object 506 and the object motion of the target 504, whether a collision between them is likely. For example, the processing element 114 may detect that the target 504 is in the safe region 516 and thus the likelihood of a collision between the moving object 506 and the target 504 is low. In another example, a processing element 114 may determine whether the target 504 is in the intermediate region 514 and that the likelihood of a collision between the target 504 and the moving object 506 may be elevated compared to the case where the target 504 is in the safe region 516 (i.e., medium likelihood). In another example, a processing element 114 may determine whether the target 504 is in the region of interest 512, such as a street, and that the likelihood of a collision between the target 504 and the moving object 506 may be elevated further compared to the cases where the target 504 is in the intermediate region 514 or the safe region 516 (i.e., high likelihood).

The method 400 may proceed to operation 420 and the processing element 114 generates a first alert. The type of alert may be based on the likelihood of a collision between the target 504 and the moving object 506. As the likelihood of a collision increases, the intensity of the alert may increase progressively. For example, if the likelihood of collision is low, the processing element 114 may cause one or more lighting assemblies 110 to illuminate. In another example, if the likelihood is medium, the processing element 114 may generate a first alert by lighting one or more lighting assemblies 110 and/or generating a sound with one or more audio outputs 106. The volume of the sound and/or the intensity of the light may be adjusted based on the ambient noise and/or sound levels for example as detected by the audio sensor 156 and/or light sensor 116, respectively. In another example, if the likelihood of a collision is high, the processing element 114 may cause louder and/or more intense lights and/or animations of the lights to be generated. The lights and/or sounds may alert either or both the driver 522 and a target 504 of the likelihood of a collision. In another example, if the trajectory of a target 504 is toward the region of interest 512 (e.g., darting or sudden motion of a child chasing a ball), whether or not the target 504 is in the region of interest 512, the intensity of the first alert may be further increased.

In the operation 420, the processing element 114 may send an alert to another device, such as a user device 502 such as a phone, tablet, computer or the like. The alert may be sent to the user device 502 via the network interface 122 and the network 520 to the user device 502. For example, the user device 502 may be associated with a caregiver 510 such as a parent. The safety alert device 100 may detect a dangerous condition such as a likelihood of a collision between the moving object 506 and the target 504 and send a text message, email, phone call, or the like to the caregiver 510. Thus, the safety alert device 100 may alert the caregiver 510 to dangerous conditions in the scene 518 and the caregiver 510 can take appropriate action such as retrieving the target 504 from the street. In the operation 420, the safety alert device 100 may open a communications session between the safety alert device 100 and another device such as a user device 502. For example, the safety alert device 100 and the user device 502 may send and receive spoken communication therebetween. Thus, a caregiver 510 may be able to ask the target 504 a question, such as “are you OK?” The target 504 may be able to respond to the caregiver 510 via the audio sensor 156. In another example, the safety alert device 100 may send an alert to law enforcement personnel to alert them of the dangerous conditions. The alert may include image or other data related to the moving object 506, such as an image of the moving object 506 (e.g., an image of the driver 522 and/or license plate) with its motion data such as speed.

In the operation 416 where a target 504 is not present in the scene 518 and the moving object 506 motion is at or above the object motion threshold, a processing element 114 may generate a second alert, such as illuminating one or more lighting assemblies 110, generating a sound with one or more audio outputs 106, or the like. Thus, the safety alert device 100 may alert drivers to the possible presence of targets 504 or other risks.

The operations of the method 300 and/or the method 400 may be executed in an order other than as shown, and/or may be executed in parallel. The operations of the method 300 and/or the method 400 may be executed by any processing element 114 associated with the safety alert device 100, for example the processing element 114a, the processing element 114b, and/or another processing element 114 (e.g., a processing element on a server or the user device). Some operations may be executed by one processing element 114, while other operations are executed by another processing element 114.

In another example of using the safety alert device 100, the audio sensor 156 may receive spoken communications. The processing element 114 may perform a speech recognition algorithm and may trigger an alert based on detected speech. For example, a processing element 114 may be configured to recognize a trigger word or phase such a “slow down” or “help” and may trigger a first or second alert as discussed above in response. Similarly, a processing element 114 may be configured to detect a horn honk from a car, the sound of screeching tires, screaming, crying, or crumpling metal and trigger an alert in response.

A first or second alert may also trigger the recording of video or audio from the image capture device 124a,b and/or audio user input 132. The video and/or audio may be logged to memory 136 such as internal memory or a removable memory 136 like an SD card. The video/audio may be logged to a buffer such as a first-in-first-out (“FIFO”) buffer such that the safety alert device 100 records a rolling set of video/audio. The captured audio/video may be transmitted to another device by the network interface 122, if the safety alert device 100 is so equipped.

An alert may also be triggered by a user interaction with the user input 132. For example, the user input 132 may be a help button, such that when pressed, the user input 132 causes a processing element 114 to generate a first alert, second alert, or take any other action of the methods 300 and/or 400. The user input 132 may be configured to take different actions based on the user interaction. For example, a short press on the user input 132 may indicate that the safety alert device 100 should open a communications link with another device such as the user device 502. In another example, a long press on the user input 132 may indicate that the target 504 is requesting help.

In another example, a device such as a user device 502 may be able to push a notification to the safety alert device 100. For example, the user device 502 may be configured to send a command to the safety alert device 100 via the network interface 122 that causes the safety alert device 100 to play, via an audio output component 106, a pre-determined and/or recorded message such as “time for dinner” or “it will be dark soon.” In another example, the safety alert device 100 may play such a pre-recorded message based on a timer, an ambient light level as detected by the light sensor 116, or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application. Additionally, word such as “above”, “below”, “front”, “back”, “left”, “right”, “top”, “bottom”, and the like are intended to be illustrative only to aid in understanding of the specification and are in no way limiting.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A safety alert device comprising:
a processing element; and
an image sensor in operative communication with the processing element; wherein the processing element is configured to:
receive image data of a region of interest;
determine a presence of a moving object in the region of interest based on the image data;
identify a presence of a person in the region of interest based on the image data;
determine a likelihood of a collision between the moving object and the person; and
generate, based on the likelihood being above a threshold, an alert.

2. The safety alert device of claim 1, wherein the processing element comprises:
a first processing element executing an object detection algorithm; and
a second processing element, operatively coupled to an alert assembly, wherein the presence of the moving object in the image data is determined by the first processing element via the object detection algorithm, and the alert is generated by the second processing element via the alert assembly.

3. The safety alert device of claim 2, wherein the first processing element executes an artificial intelligence algorithm configured to determine a type of the moving object.

4. The safety alert device of claim 2, further comprising:
a first circuit assembly including the first processing element; and
a second circuit assembly including the second processing element.

5. The safety alert device of claim 1, further comprising a user input configured to be activated by a user, wherein the user input is configured to initiate a communications session between the safety alert device and another device.

6.-7. (canceled)

8. The safety alert device of claim 5, wherein the communications session comprises a push-to-talk session such that when the user activates the user input, the safety alert device captures and sends at least one of audio or video to the another device, and when the user ceases activating the user input, the safety alert device is configured to receive at least one of audio or video from the another device.

9. (canceled)

10. The safety alert device of claim 1, further comprising an alert assembly configured to generate the alert, wherein the alert assembly includes at least one of a light or an audio output.

11. (canceled)

12. The safety alert device of claim 10, wherein generating the alert includes at least one of illuminating the light or generating a sound with the audio output.

13. The safety alert device of claim 1, wherein the alert is generated based on a sudden motion of the person.

14. The safety alert device of claim 1, wherein identifying the presence of the person includes determining a skeletal structure of the person.

15. A method of providing a safety notification comprising:
receiving, by a processing element, image data of a region of interest;
determining, by the processing element, a presence of a moving object in the region of interest based on the image data;
identifying, by the processing element, a presence of a person in the region of interest based on the image data;
determining, by the processing element, a likelihood of a collision between the moving object and the person; and
generating, by the processing element, based on the likelihood being above a threshold, an alert.

16. The method of claim 15, wherein the processing element comprises:
a first processing element executing an object detection algorithm; and
a second processing element, operatively coupled to an alert assembly, wherein the presence of the moving object in the image data is determined by the first processing element via the object detection algorithm, and the alert is generated by the second processing element via the alert assembly, wherein the alert assembly includes one of a light or an audio output.

17. (canceled)

18. The method claim 16, further comprising recognizing the moving object by an artificial intelligence algorithm executed by the first processing element.

19. The method of claim 15, further comprising determining, with the processing element, a scene based on the image data.

20. The method of claim 19, wherein the scene includes:
the region of interest;
an safe region; and
an intermediate region between the region of interest and the safe region.

21. The method of claim 20, wherein the likelihood of the collision of the moving object to the person is based on the presence of the person in one of the region of interest, the intermediate region, or the safe region.

22. A safety alert device comprising:
a housing comprising an illumination area;
a base coupled to the housing and configured to support the housing on a surface;
a head removably coupled to the housing, wherein the head comprises:
a circuit assembly,
one or more sensors in electrical communication with the circuit assembly, and
at least one of an image capture device, an audio output, or a user interface.

23.-25. (canceled)

26. The safety alert device of claim 22, further comprising a lighting assembly corresponding to a shape of the housing.

27. The safety alert device of claim 22, further comprising a handle removably connected to the housing, wherein the handle secures the head to the housing.

28.-29. (canceled)

30. The safety alert device of claim 26, wherein:
the circuit assembly is received in the head;
the head includes a first plurality of electrical contacts and the housing includes a second plurality of electrical contacts; and
the first plurality of electrical contacts and the second plurality of electrical contacts form an electrical connection between the head and the housing when the head is coupled to the housing.

31.-35. (canceled)
